(19) United States
(12) Patent Application Publication
(10) Pub. No.: US 2004/0200695 A1
(43) Pub. Date: Oct. 14, 2004

(54) Ez-Loader an apparatus to assist in loading and unloading objects in vehicles and work spaces

(76) Inventor: Otis Neal Armour, Houston, TX (US)

Correspondence Address: Otis Armour, 2018 Ottawa, Houston, TX, 77043, US

(21) Appl. No.: 10/412,013

(22) Filed: Apr. 14, 2003

(51) Int. Cl. B65G 29/00

(52) U.S. Cl. 198/414; 414/537

(57) ABSTRACT

A machine for assisting loading and unloading objects in vehicles, stationary platforms, trailers with Dual V Groove Bearings mounted in a Cantilever design for superior tracking and strength, Cantilever Carrier Assembly allows for a small installation footprint, Cantilever Rails allow full weight support throughout the entire range of travel, Through the use of Interchangeable “SKINS” specific tasks relative to the tradesmen's requirements will allow the Ez-Loader to have a multi-function purpose including but not limited to loading platform and work area, Manual or Motorized extension and retraction of the “SKIN” and complete support system Retractable and Adjustable Ramps allow objects to be rolled up and onto the Ez-Loader, and Low “SKIN” height enables the Ez-Loader to easily fit under over rail tool boxes.

### CROSS REFERENCE TO RELATED APPLICATIONS

This application is based on provisional application serial No. 60/231876, filed on Sep. 12, 2000.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

The present invention relates generally to Ez-Loader and more specifically it relates to a apparatus to assist in loading and unloading objects in vehicles for providing an efficient means for loading and unloading cargo, tools, machines and materials outside a vehicle and sliding the cargo inside the bed to a resting position. The purpose of this invention is also to provide and utilize “SKINS” that can interchanged to change the specific function of the invention. This invention also can be utilized as a work surface that can be extended beyond the vehicles bed to allow a tradesmen to complete his project. Though the use of the “SKIN” the invention can perform specific tasks relative to the “SKINS” design, such as loading, unloading and transportation of personal water crafts, motorized recreational vehicles and tool boxes.

### DESCRIPTION OF THE PRIOR ART

Various equipment has been developed to assist loading cargo into and unloading it from motor vehicles. U.S. Pat. No. 3,687,314 illustrates a dolly that rolls on the floor of a truck. A platform is hinged to the dolly. The platform may be tilted to contact the round or to lie flat on the truck bed. The container of U.S. Pat. No. 4,303,367 rides on rails attached to a station wagon floor without rollers and is therefore limited to carrying light loads. The platforms of the aforementioned patents possess certain disadvantages that restrict their usefulness. Another disadvantage of prior designs involves the structures for securing the movable platforms in place, both in the extended and retracted positions. For example, the designs of U.S. Pat. No. 3,471,045 and U.S. Pat. No. 3,826,472 depend on the truck tailgate to hold the retracted movable carriage or rack in place. With such a design, the truck cannot be parked with the back end sloping down hill, because the carriage or rack will dangerously roll backward immediately upon lowering tailgate. The locking means of U.S. Pat. No. 3,726,422 employs a pin that extends into the luggage area where it is awkward to reach. The main problem with conventional technologies are it is limited in its ability to perform to specific trades. Another problem with conventional Ez-Loader are its lack of motorized operation. Another problem with conventional Ez-Loader are it does not have the ability to transform its function by replacing the “Skin” depending on its requested task. While these devices may be suitable for the particular purpose to which they address, they are not as suitable for providing motorized, Cantilever operation with interchangeable “Skins” and retractable ramps. Nor do they provide an efficient means for loading and unloading cargo, tools, machines and materials outside a vehicle and sliding the cargo inside the bed to a resting position. The purpose of this invention is also to provide and utilize “SKINS” that can interchanged to change the specific function of the invention. This invention also can be utilized as a work surface that can be extended beyond the vehicles bed to allow a tradesmen to work on his project. Through the use of the “SKIN” the invention can perform specific tasks relative to the “SKINS” design, such as loading, unloading and transportation of personal water crafts, motorized recreational vehicles and tool boxes. The main problem with conventional Ez-Loader are it is limited in its ability to perform to specific trades and needs of the user. Another problem is its lack of motorized operation. Also, another problem is it does not have the ability to transform its function by replacing the “Skin” depending on its requested task. Another problem is they do not incorporate hideaway ramps, cantilever rail system.

In these respects, the apparatus to assist in loading and unloading objects in vehicles according to the present invention substantially departs from the conventional concepts and designs of the prior art, and in so doing provides an apparatus primarily developed for the purpose of providing an efficient means for loading and unloading cargo, tools, machines and materials outside a vehicle and sliding the cargo inside the bed to a resting position. The purpose of this invention is also to provide and utilize “SKINS” that can interchanged to change the specific function of the invention. This invention also can be utilized as a work surface that can be extended beyond the vehicles bed to allow a tradesmen to work on his project. Through the use of the “SKIN” the invention can perform specific tasks relative to the “SKINS” design, such as loading, unloading and transportation of personal water crafts, motorized recreational vehicles and tool boxes. There are no prior technologies that utilize the “SKIN” capabilities. There are no motorized technologies implemented in this type of application that provide the same function as the Ez-Loader system. No other unit exists for this type of application the utilizes the Cantilever Carrier Rail System design.

### BRIEF SUMMARY OF THE INVENTION

The primary object of the invention is to assist in loading and unloading objects outside the vehicle and by means of either hand or motorization retract the load into the vehicle.

Another object of the invention is to provide a retractable and extendable work platform available in any position.

Another object of the invention is to provide a means changing the function of use between different needs by utilizing a “SKIN”.

A further object of the invention is to allow the relocation of objects from outside the vehicle cargo area to the inside vehicle cargo area unassisted by means of motorization.

Yet another object of the invention is to allow the safe means of loading, transporting and unloading of personal watercrafts.

Still yet another object of the invention is to assist in loading and unloading objects in vehicles that may be easily manufactured and market.

Another object of the invention is to assist in loading and unloading objects in vehicles that can be used as a tool or item storage device that can be extended outside the vehicle.

Another object of the invention is to allow vehicles to be loaded onto the Ez-Loader from the ground by utilizing the hideaway ramps.

Another object of the invention is to provide an extended surface area outside the normal surface area that can be used for carrying extended length loads without the need for an addition device.

Yet another object of the invention is to provide a secure way to transport scuba tanks.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for assisting loading and unloading objects in vehicles, stationary platforms, trailers comprising: Dual V Groove Bearings mounted in a Cantilever design for superior tracking and strength, Cantilever Carrier Assembly allows for a small installation footprint, Cantilever Rails allow full weight support throughout the entire range of travel, Interchangeable “SKINS” allow the Ez-Loader to have a multi-function purpose, Manual or Motorized extension and retraction of the “SKIN” and complete support system Retractable and Adjustable Ramps allow objects to be rolled up and onto the Ez-Loader, and Low “SKIN” height enables the Ez-Loader to easily fit under over rail tool boxes.

In accordance with a preferred embodiment of the invention, there is disclosed a process for assisting loading and unloading objects in vehicles, stationary platforms, trailers while providing a stable work area in retracted, extended and all positions in-between. Also the unit provides the process of retracting said objects to the front of the loading platform and then extending same for removal and comprising the steps of: Dual V Groove Bearings for superior tracking and strength, Cantilever Carrier Assembly allows for a small installation footprint, Cantilever Rails allow full weight support throughout the entire range of travel, Interchangeable “SKINS” allow the Ez-Loader to have a multi-function purpose, Motorized extension and retraction of the “SKIN” allows for labor free operation, Hideaway Retractable and Adjustable Ramps mounted within the Ez-Loader, and Low “SKIN” height enables the Ez-Loader to easily fit under over rail tool boxes.

In view of the foregoing disadvantages inherent in the known types of Ez-Loader now present in the prior art, the present invention provides a new apparatus to assist in loading and unloading objects in vehicles construction wherein the same can be utilized for providing an means for loading and unloading cargo, tools, machines and materials outside a vehicle and sliding the cargo inside the bed to a resting position. The purpose of this invention is also to provide and utilize “SKINS” that can interchanged to change the specific function of the invention. This invention also can be utilized as a work surface that can be extended beyond the vehicles bed to allow a tradesmen to complete his project. Through the use of the “SKIN” me invention can perform specific tasks relative to the “SKINS” design, such as loading, unloading and transportation of personal water crafts, motorized recreational vehicles and tool boxes.

The general purpose of the present invention, which will be described subsequently in greater detail, is to provide a new apparatus to assist in loading and unloading objects in vehicles that has many of the advantages of the Ez-Loader mentioned heretofore and many novel features that result in a new apparatus to assist in loading and unloading objects in vehicles which is not anticipated, rendered obvious, suggested, or even implied by any of the prior art Ez-Loader, either alone or in any combination thereof.

To attain this, the present invention generally comprises a unique Dual V Groove, cantilever carrier and rail assembly, a “SKIN”, and a motor that the unique “SKIN” mounts to. The SKIN is the template that decides the inventions function for a particular application. The Rail is a custom formed guide rail that connects to the “SKIN” and to the crossmember. The Crossmember secures the Rails, provides mounting for the SKIN and Gear Rail. The Carrier provides the mounting strength for the cantilever wheel and rail assembly. The Base provides alignment and strength for installation and operation of the Ez-Load System. The Gear Rail provides the means by which the invention is moved by the motor. The motor operates the invention from a retracted position to anyone of many extended positions. The Adjuster controls motor and gear rail alignment. It also allows disengagement in case of failure. The Underbody Bracket provides a secure support for mounting of the base to the vehicle. The Litter provides a secure stop of motion for the travel of the rails. The Dual V Guide wheel provides the method in which precision linear motion is accomplished. The BX Bushing provides an eccentric mounting hole for adjustment of wheel alignment. The Bushing provides a concentric mounting hole with low friction for the wheel to rotate on. The Angle Capture provides torsional support for the rail and adds mounting surface area to the rail. The SG Bracket secures the SKIN to the Crossmember and facilitates a quick removal. The hoedown secures the SKIN to the rail assembly and provides a quick release. The Pockets allow for storage of items within and outside the skin. The Slider Trac is mounted to the SKIN and allows items to slide to the front or rear of the SKIN. The Adjuster Bracket is stationary and maintains a controlled rotation point for the screw arm. The Screw Arm controls the travel and alignment of the Motor.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a apparatus to assist in loading and unloading objects in vehicles that will overcome the shortcomings of the prior art devices.

An object of the present invention is to provide a apparatus to assist in loading and unloading objects in vehicles for providing an efficient means for loading and unloading cargo, tools, machines and materials outside a vehicle and sliding the cargo inside the bed to a resting position. The purpose of this invention is also to provide and utilize “SKINS” that can interchanged to change the specific function of the invention. This invention also can be utilized as a work surface that can be extended beyond the vehicles bed to allow a tradesmen to complete his project. Through the use of the “SKIN” the invention can perform specific tasks relative to the “SKINS” design, such as loading, unloading and transportation of personal water crafts, motorized recreational vehicles and tool boxes.

Another object is to provide a apparatus to assist in loading and unloading objects in vehicles that provides a motorized retractable apparatus that can be transformed to perform a wide variety of specific tasks and can be easily removed from the vehicle.

Another object is to provide a apparatus to assist in loading and unloading objects in vehicles that provides effortless loading, moving and unloading of cargo and tools through the use of the cantilever rail system. It also provides the capability of having an extendable and retractable loading and working surface.

Another object is to provide a apparatus to assist in loading and unloading objects in vehicles that provides a motorized loading system for vehicles.

Another object is to provide a apparatus to assist in loading and unloading objects in vehicles that can be converted for different uses by simply changing the “SKIN”.

Another object is to provide a apparatus to assist in loading and unloading objects in vehicles that provides a safe means to load, transport and unload personal watercrafts.

Another object is to provide a apparatus to assist in loading and unloading objects in vehicles that may be easily manufactured and marketed. Another object is to provide a apparatus to assist in loading and unloading objects in vehicles that can be used as a tool or item storage device that can be extended outside the vehicle.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

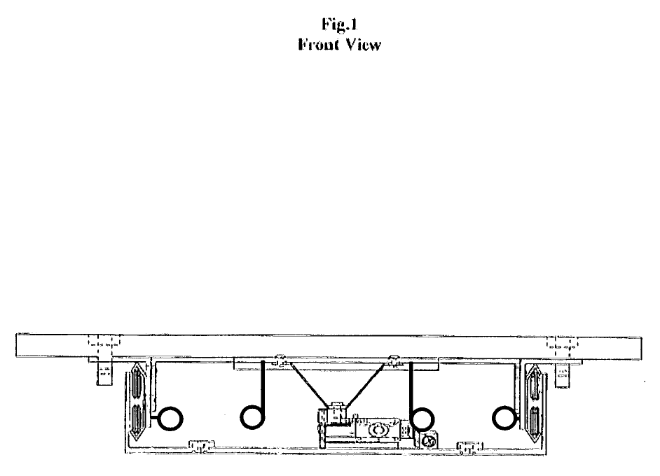

FIG. 1 is a front view of the present invention.

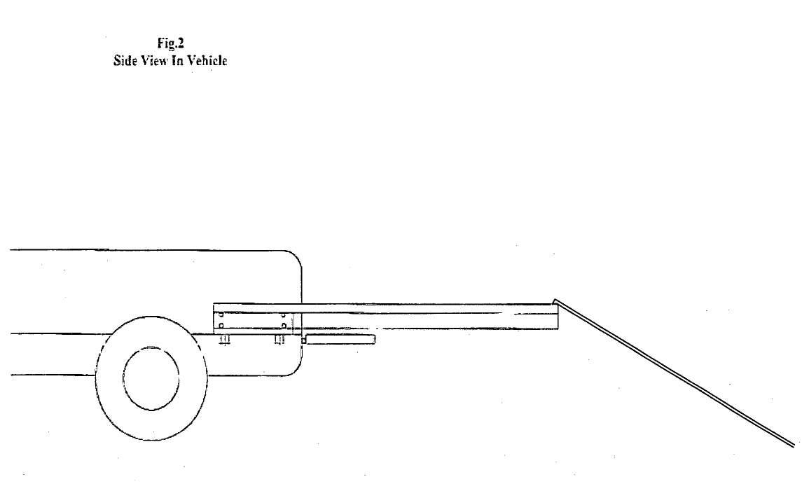

FIG. 2 is a side view of the present invention.

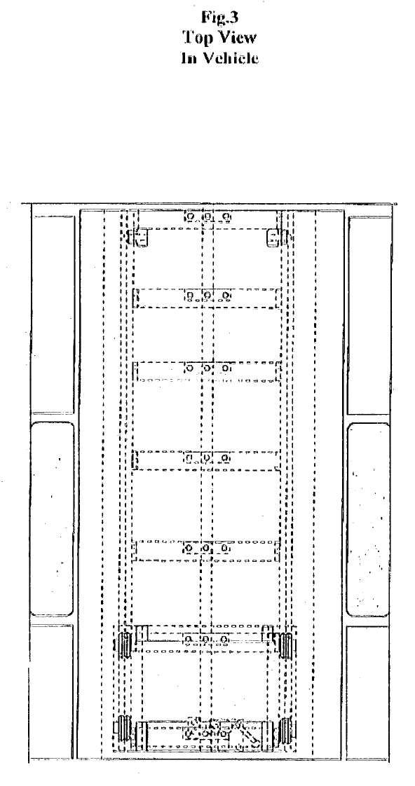

FIG. 3 is a top view of the present invention.

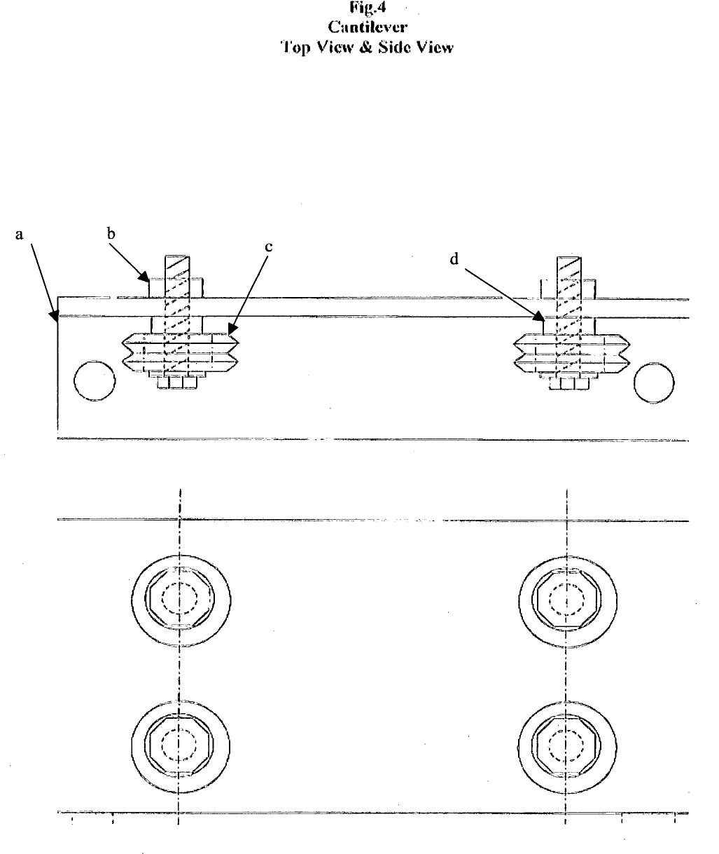

FIG. 4 is a detailed view of the cantilever carrier.

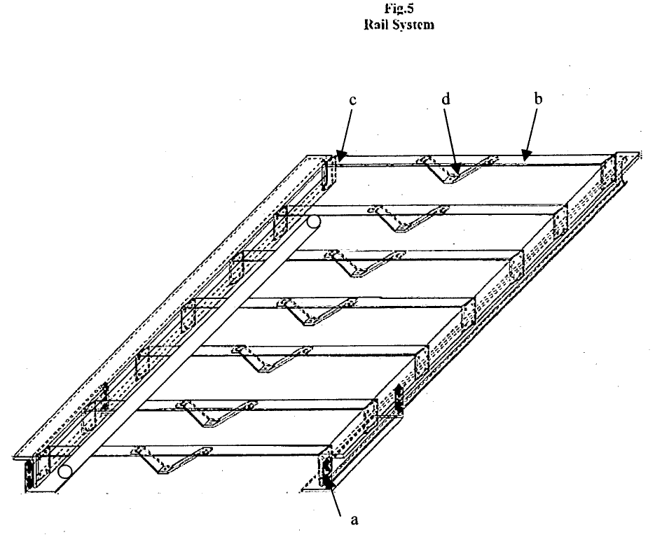

FIG. 5 is a view of the rail system.

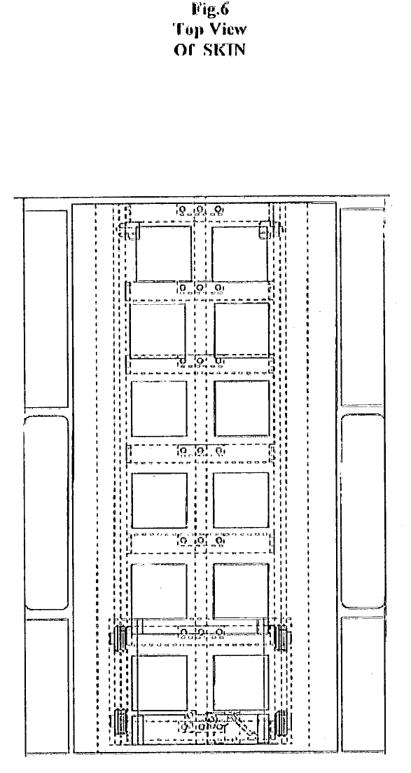

FIG. 6 is a view of the SKIN and pockets.

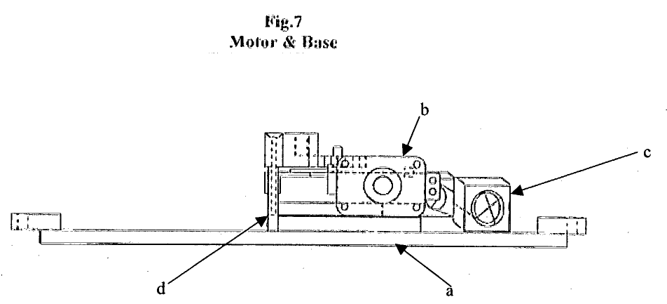

FIG. 7 is a detailed view of the motor and Base.

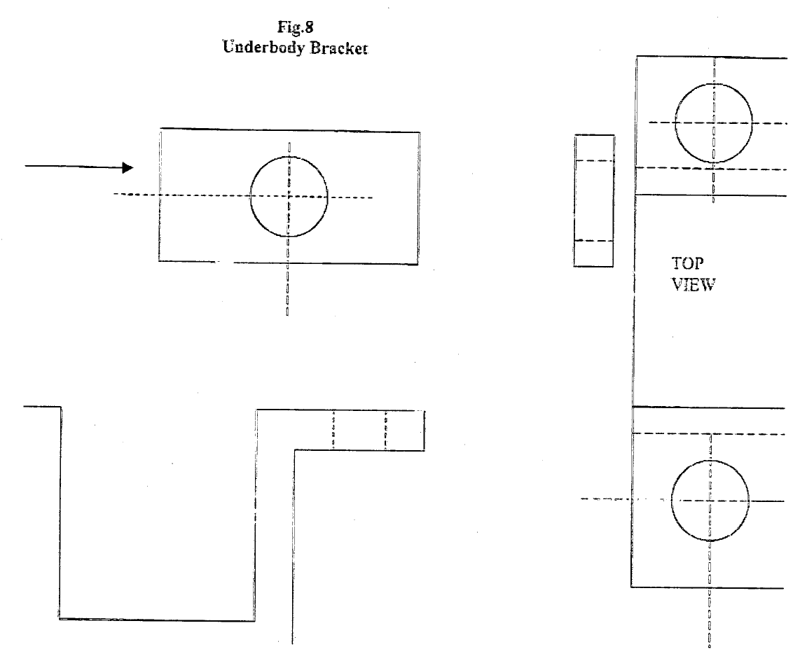

FIG. 8 is a detailed view of the underbody bracket.

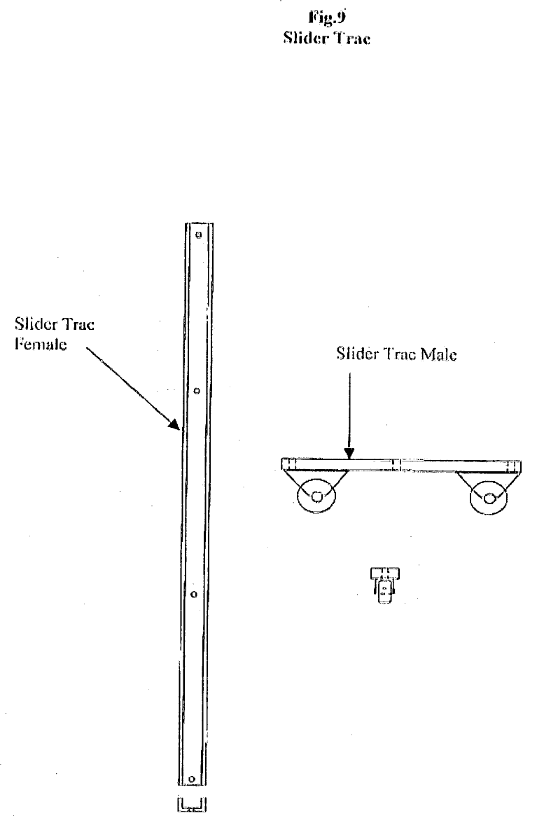

FIG. 9 is a view of the slider bracket.

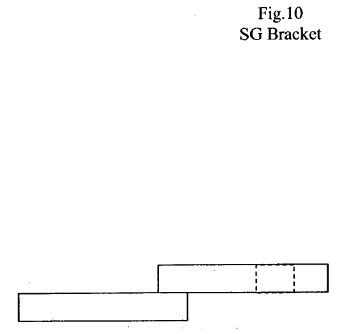

FIG. 10 is a view of the SG bracket.

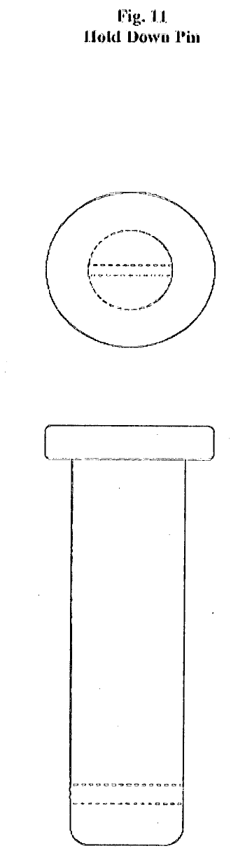

FIG. 11 is a view of the hold down pin.

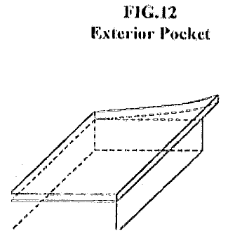

FIG. 12 is a view of the exterior pocket.

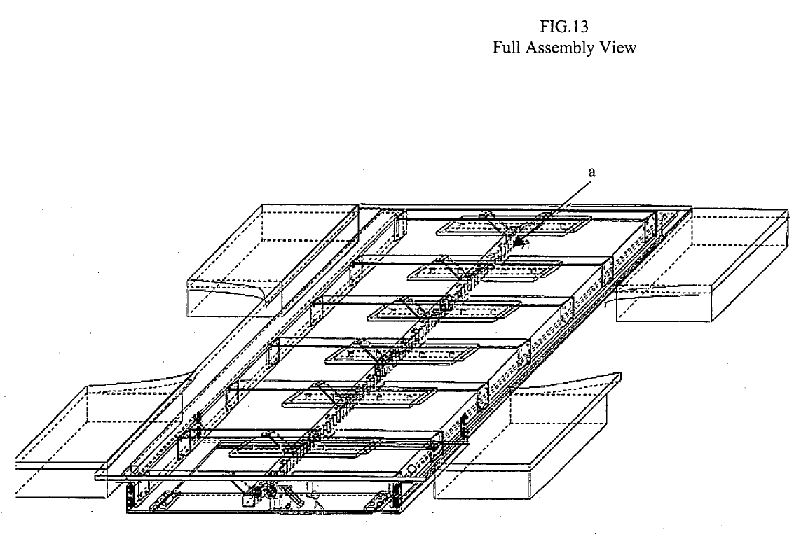

FIG. 13 is a full view of the Ez-Loader assembly.

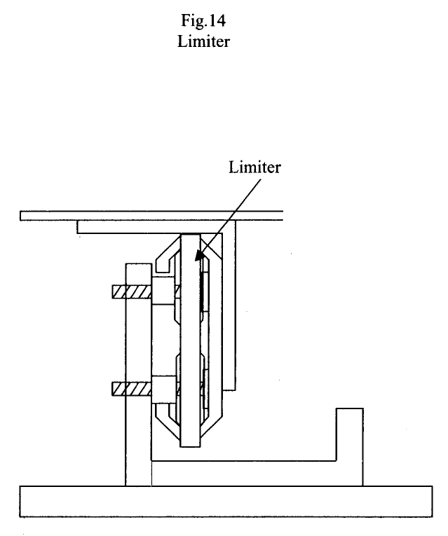

FIG. 14 is a full view of the limiter

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DESCRIPTION OF THE PREFERRED EMBODIMENT

Turning now descriptively to the drawings, in which similar reference characters denote similar elements throughout the several views, the attached figures illustrate a machine assisting in the loading and unloading objects in vehicles or trailers comprising a unique and superior Dual V Groove cantilever carrier and rail assembly FIG. 4, a “SKIN” FIG. 6, and a motor FIG. 7 that the unique “SKIN” FIG. 6 mounts to. The “SKIN” FIG. 6 is the template that decides the inventions function for a particular application. The Rail FIG. 5a is a custom formed guide rail that connects to the “SKIN” FIG. 6 and to the crossmember FIG. 5b. The Crossmember secures the Rails FIG. 5c, provides support for the “SKIN” FIG. 6 and Gear Rail FIG. 5d. The Carrier FIG. 4a provides the mounting strength and small footprint for the complete cantilever wheel and rail assembly FIG. 4. The Base FIG. 7a provides alignment and strength for installation and entire operation of the Ez-Loader System. The Gear Rail FIG. 13a, mounted to the crossmember provides the means by which the motorized inventions travel is achieved. The motor FIG. 7b operates the invention and enables it to be retractable and extendable. The Adjuster FIG. 7c controls motor and gear rail alignment. It also allows disengagement in case of failure. The Underbody Bracket FIG. 8 provides a secure support from the underside of the mounting surface for mounting of the base to the vehicle. The Limiter FIG. 14 provides a secure stop of motion for the travel of the rails. The Dual V Guide wheels FIG. 4c which are mounted to the carrier FIG. 4b provides the method in which precision linear motion is accomplished. The BX Bushing provides an eccentric mounting hole for adjustment of wheel alignment. The Bushing provides a concentric mounting hole with low friction for the wheel to rotate on. The Angle Capture FIG. 1a provides torsional support for the rail and adds mounting surface area to the rail. The SG Bracket FIG. 10 secures the SKIN to the Crossmember and facilitates a quick removal. The Hold down FIG. 11 secures the SKIN to the rail assembly FIG. 5 and provides a quick release. The Pockets allow for storage of items within and outside the skin. The Slider Trac FIG. 9 is mounted to the SKIN and allows items to slide to the front or rear of the SKIN. The Adjuster Bracket FIG. 7d is stationary and maintains a controlled rotation point for the screw arm FIG. 7c. The Screw Arm FIG. 7c controls the travel and alignment of the Motor FIG. 7b.

The SKIN is the Interchangeable template platforms that decides the inventions function for a particular application. The wheel is a Dual V groove wheel that is designed to allow the rail to travel in a cantilever motion. The wheel provides a low friction accurate linear slide surface. The wheels are precision ground, double row angular contact ball bearings, which are pre-lubricated and sealed for durability. The operation. The wheel has a ground, double row, angular contact ball bearings, ABEC-1, pre-lubricated, external surfaces lightly oiled with SAE 52100 Steel, hardened 60-62 Rockwell C Shield. The wheel comes in 4 series of sizes and capacities. The Series 4 wheel is 2.36″ in diameter and 0.75″ in width with a 0.5906 bore. The Series 3 wheel is 1.80″ in diameter and 0.625″ in width with a 0.4724″ bore. The Series 2 wheel is 1.21″ in diameter and 0.437″ in width with a 0.5″ bore. The Series 1 wheel is 0.77″ in diameter and 0.310″ in width with a 0.1875″ bore. The dynamic radial Capacities for the wheels are as follows: Series 1:345 lbs at 33.3 rpm 240 lbs at 100 rpml 40 lbs at 500 rpm; 10 lbs at 1000 rpm Series 2:700 lbs at 33.3 rpm 485 lbs at 100 rpm 285 lbs at 500 rpm 225 lbs at 1000 rpm Series 31330 lbs at 33.3 rpm 920 lbs at 100 rpm 540 lbs at 500 rpm 430 lbs at 1000 rpm Series 42000 lbs at 33.3 rpml 385 lbs at 100 rpm 810 lbs at 500 rpm 645 lbs at 1000 rpm. The Rail is a custom formed guide rail that connects to the “SKIN” and to the crossmember. The Rail consists of pressed formed steel. The rail shape is a main component of the EZ-Loader. It provides the cross-sectional strength and alignment of the system. When formed the rail becomes a shape that can be described in the following way. The rails shape is a “C” channel in its basic formation. The difference is that the rails top and bottom surface of the rail form an additional angle of 90 degrees. This additional angle provides support for the SKIN and allows the WHEEL to track within the rail. This tracking motion is radial/outward in design and provides the low coefficient of friction that allows the rail to move easily through its length of travel. The Rail is the encased with the Angle Control. This piece creates added strength to the rail, provides addition mounting surface area to the rail and provides additional support for the SKIN. This piece is called the angle capture. The rail can vary in its physical dimensions depending on the version and load capacity required by the application. There is no limit to the size of the rail. The rail functions as a support for the skin. The rail provides mounting locations for the cross member assembly and provides a linear tracking arm for the wheels to rotate within.

The Crossmember secures the Rails, provides mounting for the SKIN and Gear Rail. The Carrier consists of a structure that forms an “L” shape or a “C” shape depending upon model of EZ-LOADER and the specific application. This Carrier is milled to retain the wheel assembly and provide mounting location holes to the mounting surface that secure the carrier to the vehicle or object. The wheel assembly consists of eccentric and concentric bushings, mounting nuts, bolts, and wheels. The carrier contains several mounting holes for the wheel assembly. The Carrier is mounted by use of a quick release device allowing for the easy removal of the Carrier from the vehicle. The carrier can be made of metal, aluminum, or composite materials depending upon the specific model of EZ-Loader and its exact application. The carriers mounting locations for the wheel assembly are variable depending on the application desired. The Carrier can be formed in either a “C” Channel shape or an “L” shape. Some versions of the carrier retains only two wheel assemblies while other versions retain 4 wheel assemblies. This design is as variable as applications. This design is not limited in its function or form.

The Carrier provides the mounting strength for the cantilever wheel and rail assembly. The SKIN is the key to the wide range of multi-applications and uses for the EZ-Loader. The SKIN can best be described as a component that is manufactured for specific and generic applications. It takes on many different forms and functions yet retain its ability to mount on the RAILS and slide out of the vehicle. The SKIN is a template for the EZ-Loader. It allows the myriad of applications to be carried out depending on its layout. The SKIN mounts to the Rails/Angle Capture assembly and cross members by means of underside slip groove (SG) brackets and is secured in place by a set of hold down pins. The SKIN can be made of metal. Composite or wood. This SKIN has pre configured mounting positions located throughout its surface to facilitate the mounting of specific items. Items can range anywhere from but is not limited to tools, machines, devices, cargo and vehicles. The SKIN can contain POCKETS for storage depending on the application. Some versions of the SKIN have a Rubber based coating applied to provide a non-slip surface and to add protection to the SKIN. The Base provides alignment and strength for installation and operation of the EZ-Loader System. The base interconnects the carrier to the vehicle, aligns the carriers and also provides the mounting surface for the motor. The base is the support plate for the EZ-Loader. Its main function is to interconnect the carrier to the mounting surface through a series of mounting holes milled along its surface. It has a quick release mechanism located on the front area to allow the carrier to be quickly removed by releasing the Carrier connection pin. Its other functions include alignment of the Rail/Angle control assembly in parallel to another rail/Angle control assembly, which is located on the other side of the mounting surface. The Base also provides support for the motor and motor adjustment assembly.

The retractable and adjustable hideaway ramps are located under the SKIN and mounted to the crossmembers. The ramps fully extend to the ground on one end and are permanently attached to the crossmembers on the other. These ramps may be adjusted by sliding the end connected to the crossmember either in our out. The ramps facilitate the loading or unloading by means of a hand cart. Another function of the ramps is to allow vehicles to be rolled into the vehicle or trailer platform.

The Gear Rail provides the means by which the invention is moved by the motor. The motor provides the powered means to move the Ez-Loader its full length of travel from a resting position to an extended position. The motor is a low speed gear reduction type that is mounted to a base plate. The base plate is mounted to the base, has a pivot point and can be aligned or adjusted by the adjuster. The location of the motor can vary depending on the version of EZ-Loader. The motors gear interconnects to the Gear Rail to facilitate linear travel. The motors alignment can be adjusted by means of the Alignment Screw. This adjustment also allows the motor to disengage from the Gear rail to allow for manual operation of the EZ-Loader.

The motor operates the invention from a retracted position to anyone of many extended positions. The Gear Rail provides meshing of the motor and the EZ-Loader to facilitate back-and-forward motion of the EZ-Loader by the motor. The Gear Rail is connected to the cross member and runs the length of the Rail. The exact location of the Gear Rail will vary according to the EZ-Loaders' application.

The Adjuster controls motor and gear rail alignment. It also allows disengagement in case of failure. The Adjuster maintains the alignment between the motor and the Gear Rail. The Adjuster is located under the Gear Rail Assembly and mounts to the base. The Adjuster itself is a Screw type system. The Adjusters Screw arm connects to an Adjuster Bracket that is mounted in a stationary position to the base plate.

The Underbody Bracket provides a secure support for mounting of the base to the vehicle. The Underbody Bracket provides support area for the mounting bolt. The Underbody Bracket is located on the underside of the vehicle. The functional purpose of the Underbody Bracket is to secure the base to the vehicle by means of mounting screws. The Underbody Bracket has a larger surface area that helps distribute the upward force of the mounting bolt to a larger area.

The Limiter provides a secure stop of motion for the travel of the rails. The limiter stops the linear motion of the rail at a predetermined amount of travel. The Limiter is mounted at two locations per rail. One is located at the forward end and one at the rear end. The direction of the limiter is outward of the rail. The limiter is designed to engage the carrier when the predetermined travel is reached, thereby limiting the travel of the rail.

The Dual V Guide wheel provides the method in which precision linear motion is accomplished. The cross member provides a multitude of benefits and required structural stability to the EZ-Loader. It interconnects the pair of rails in such a way as to create a structural sound and dimensionally square assembly. The Cross member is formed to fit exactly between the rails to create an exact fit. The bottom of the Crossmember is also the mounting surface for the gear rail. The cross member aligns the rails so that they tack true to the carriers.

The BX Bushing provides an eccentric mounting hole for adjustment of wheel alignment. The Bushing BX is an adjustable bushing the fits in the wheel and allows the clearance to be adjusted between the track and wheel. The Bushing BX has an eccentric mounting hole and is mounted to the base in a horizontal position. By rotating the BX bushing on its mounting bolt, the clearance between the wheel and the track can be adjusted.

The Bushing provides a concentric mounting hole with low friction for the wheel to rotate on. The Bushing in a stationary bushing that fits in the wheel and has no adjustment. The Bushing has a concentric mounting hole and is mounted to the base in a horizontal position. The major load is carried by the Bushing and not the (BX) Bushing.

The Angle Capture provides torsional support for the rail and adds mounting surface area to the rail. The Angle Capture is a formed piece that provides several functions to the EZ-Loader. It is the exact length of the rail and is formed at a 90 deg. angle. The Angle Capture provides flexion and torsion support for the rail. It is the exact length of the rail and is formed at a 90 deg. angle. The Angle Capture provides flexion and torsion support for the rail. It also provides mounting surfaces for the cross member and the SKIN.

The SG Bracket secures the SKIN to the Crossmember and facilitates a quick removal. The SG Bracket is a formed bracket that secures the SKIN to the Cross member and prevents the SKIN from sliding forward. The SG Bracket mounts to the underside of the SKIN and engages the cross member on a horizontal plane. This engagement is in the form of a slip fit where the SG Bracket fits under the cross member and creates a sandwich effect.

The Hold down secures the SKIN to the rail assembly and provides a quick release. The Hold Down PIN Secures the SKIN to the Rail assembly. The Hold down pin allows the SKIN to be securely mounted and locked in position engaged in the Rail assembly. It also allows for the quick release and removal of the SKIN. There is one Hold down PIN locate at the rear end of each rail. It is mounted vertically through a mounting hole that travels through the SKIN and Rail located on the rear end of both parts. Removal of the Hold down pin is accomplished by lifting with an upward force on the Hold down PIN.

The Pockets allow for storage of items within and outside the skin. Pockets are storage containers recessed into the SKIN. These storage containers vary in size and shape depending on the SKIN version. Some Skins do not have Pockets. Pockets also are located outside the EZ-Loader. These pockets are formed to fit between the SKIN and the vehicle providing storage pockets independent of the SKIN. Pockets are formed or constructed in a variety of different sizes depending upon application. They are fit inside the skin and are recessed so that the top surface forms a flat surface with the SKIN.

Other Pockets are made to fit outside of the skin and are of the same height as the EZ-Loader. All pockets regardless of either an inside SKIN fit or outside fit are designed to hold items, tools, equipment or other objects that physically fit with the pocket.

The Slider Trac is mounted to the SKIN and allows items to slide to the front or rear of the SKIN. The Slider Trac allows for the easy movement of tool boxes from the front of the EZ-Loader to the rear of the EZ-Loader. The Slider Trac consists of three Tracs that are positioned and distributed evenly across the SKIN. The TRACS lengths are equal to the SKINS length. Each Trac consists of 2 pieces, an upper Trac and a lower Trac. The upper Trac is mounted to the toolboxes underside or to tool base mounting plates and the bottom Trac is mounted to the Pre-tapped mounting hole on the SKIN. The upper Trac contains center Groove wheels that allow the upper Trac to slide within the bottom Trac.

The Adjuster Bracket is stationary and maintains a controlled rotation point for the screw arm. The Adjuster Bracket is a devise that connects one end of the Adjuster Bracket to the Base plate. The Adjuster Bracket is a stationary bracket that is mounted to the base and allows the Adjuster Bracket to rotate freely. The Adjuster Bracket controls the amount of play or alignment between the motor and the Gear Rail.

The Screw Arm controls the travel and alignment of the Motor. The Adjuster Bracket controls the alignment and play of the motor and its relationship to the Gear Rail. The Adjuster Bracket is a threaded rod that rotates within the Adjuster Bracket and the base plate. One end of the Adjuster Bracket rotates freely within the Adjuster Bracket and the other end is connected to the base plate by means of a threaded hole. When the adjuster Bracket is turned the resulting action is movement of the base plate up the base.

The EZ-Loader is connected in the following manner. The Motor is connected to the base by means of the base plate. The motor is mounted to the base plate by means of a single pivot bolt. The Adjuster Bracket is threaded into the base plate and inserted into the Adjuster Bracket. The Adjuster Bracket is mounted to the base by means of two mounting bolts. The Base is then secured to the mounting surface by means of (4) four mounting bolts, which are inserted through the mounting surface and then secured by the underbody bracket. Next the bushings are inserted into the wheels. The Concentric bushings are inserted into the bottom front and the top rear locations on the Carrier and the Eccentric bushings are inserted into the top front and bottom rear locations on the carrier. The Carrier is mounted and secured in place on top of the base. The Rails are then mounted to the Angle Controls and secured by means of pop rivets located along its length. The Limiter PIN is then installed through the rail assembly and secured in place by a lock washer and nut. Next the Cross members are riveted to both of the rail assemblies. Once riveted the rail assembly and cross member is installed over the wheels and on the Carrier. The Gear Rail is then slid underneath the rail assembly, aligned to the motor gear and mounted to the cross member with mounting bolts. The SG Brackets are attached to the “SKINS” underside and the SKIN is slid over the rail assembly making the SG Brackets sandwich the Cross member. It is then secured by the hold down pins, which are inserted into the rail assembly through the SKIN. Final connections are then made for electrical power to the motor. The red wire connects to 12 v Positive voltage and the black wire connects to 12 v negative power. Unit is controlled via an on/off switch mounted to the vehicle. The SKIN variations are almost unlimited as they are made per application. As a new application become required new SKINS are produced to fill the application. Size and Cargo weight specifications vary depending upon application.

Current models are anywhere between 5.5″ to 15″ in height and handle weights of 0 lbs to over 10,000 lbs. Depending on the application the EZ-Loader can range from 39″ to 48″ in width and from 72″ to 96″ in length. Once again the application determines the size and the applications are almost limitless. Units can be operated without a motor and can be removed from the vehicle.

The EZ-Loader operates by simply pushing a two-way momentary button. As the button is pressed in one direction the the EZ-Loader effortlessly slides out of the vehicle to an extended position. This motion is accomplished my use of a motor located under the Cross member at the rear of the vehicle. The motor tracs on a Gear Rail assembly, which is located under and mounted to the Cross member. The EZ-Loader is unique in that it has SKINS that are interchangeable. These SKINS determine the actual application of the EZ-Loader. Once the EZ-Loader is in full extension it can be used in several ways. One way to use the EZ-Loader is to simply load your Cargo on the extended SKIN push the button and have the EZ-Loader retract to a resting position inside the vehicle. Another way is as a work area and depending on which SKIN version is being used you can weld, hammer, saw, cut tile or more. There is almost an unlimited number of uses. With the Slide Trac installed, once the EZ-Loader has reached its extended position, a fully loaded toolbox can be slid to the furthermost extended position for easy access. Once through with the toolbox simply push the toolbox back to the front of the EZ-Loader, retraction can be performed by pushing the button. The EZ-Loader will retract into the vehicle taking the toolbox with it. If using a SKIN with internal pockets, once the SKIN is extended pockets are easily accessible to retrieve tools or cargo that has been stored in them. Once again, once through simply pushing the button the EZ-Loader will retract to a position inside the bed. With the PWC (Personal Water Craft) SKIN installed loading the PWC is simple. First Extend the EZ-Loader and backup the vehicle to the water, allowing the EZ-Loader to enter the water. Once in the water simply drive the PWC off the EZ-Loader. When reloading the PWC simply drive the PWC up onto the extended EZ-Loader.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for assisting loading and unloading objects in vehicles, stationary platforms, trailers comprising:
Dual V Groove Bearings mounted in a Cantilever design for superior tracking and strength;
Cantilever Carrier Assembly allows for a small installation footprint;
Cantilever Rails allow full weight support throughout the entire range of travel;
Interchangeable “SKINS” allow the Ez-Loader to have a multi-function purpose;
Manual or Motorized extension and retraction of the “SKIN” and complete support system
Retractable and Adjustable Ramps allow objects to be rolled up and onto the Ez-Loader; and
Low “SKIN” height enables the Ez-Loader to easily fit under over rail tool boxes.

2. A process for assisting loading and unloading objects in vehicles, stationary platforms, trailers while providing a stable work area in retracted, extended and all positions in-between. Also the unit provides the process of retracting said objects to the front of the loading platform and then extending same for removal and comprising the steps of:
Dual V Groove Bearings for superior tracking and strength;
Cantilever Carrier Assembly allows for a small installation footprint;
Cantilever Rails allow full weight support throughout the entire range of travel;
Interchangeable “SKINS” allow the Ez-Loader to have a multi-function purpose;
Motorized extension and retraction of the “SKIN” allows for labor free operation;
Hideaway Retractable and Adjustable Ramps mounted within the Ez-Loader; and
Low “SKIN” height enables the Ez-Loader to easily fit under over rail tool boxes.
